(19) United States
(12) Patent Application Publication
(10) Pub. No.: US 2026/0322548 A1
(43) Pub. Date: Oct. 15, 2026

(54) TERMINAL, RADIO COMMUNICATION METHOD, AND BASE STATION

(71) Applicant: NTT DOCOMO, INC., Tokyo (JP)

(72) Inventors: Yuki Matsumura, Chiyoda-ku, Tokyo (JP); Satoshi Nagata, Chiyoda-ku, Tokyo (JP); Jing Wang, Haidian District, Beijing (CN)

(73) Assignee: NTT DOCOMO, INC., Tokyo (JP)

(21) Appl. No.: 19/099,380

(22) PCT Filed: Aug. 10, 2022
(86) PCT No.: PCT/JP2022/030541

§ 371 Date: Jan. 28, 2025

(51) Int. Cl. H04L 5/00; H04J 13/18; H04W 72/23

(52) U.S. Cl. CPC H04L 5/0048; H04J 13/18; H04W 72/23

(57) ABSTRACT

A terminal according to one aspect of the present disclosure includes a receiving section that receives information related to a port of demodulation reference signal (DMRS), and a control section that assumes, based on the information, that a length of an orthogonal cover code for decoding the DMRS is more than 2. According to one aspect of the present disclosure, an appropriate number of DMRS ports can be used.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP, registered trademark) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For future radio communication systems (e.g., NR), a beam management scheme is introduced. For example, for NR, forming (or using) beams in at least one of a base station and a user terminal (User Equipment (UE)) has been under study.

Meanwhile, for layer orthogonalization or the like, reference signals of a plurality of ports (for example, DeModulation Reference Signal (DMRS)) are used. In future radio communication systems, it is required to increase the number of DMRS ports as compared with existing specifications. However, studies have not yet advanced how to increase the number of DMRS ports. If an appropriate number of DMRS ports are not available, communication throughput/communication quality may be degraded.

Thus, an object of the present disclosure is to provide a terminal, a radio communication method, and a base station that use an appropriate number of DMRS ports.

### Solution to Problem

A terminal according to one aspect of the present disclosure includes a receiving section that receives information related to a port of demodulation reference signal (DMRS), and a control section that assumes, based on the information, that a length of an orthogonal cover code for decoding the DMRS is more than 2.

### Advantageous Effects of Invention

According to one aspect of the present disclosure, an appropriate number of DMRS ports can be used.

### BRIEF DESCRIPTION OF DRAWINGS

FIG. 1 shows an example of table 1 for DMRS configuration type 1.

FIG. 2 shows an example of table 1 for DMRS configuration type 2.

FIG. 3 shows an example of multiplexing of a DMRS for an existing UE and a DMRS for a new UE.

FIG. 4 shows an example of a scenario in which a DMRS for an existing UE and a DMRS for a new UE are multiplexed.

FIG. 5 is a diagram to show an example of information related to DMRS port.

FIG. 6 is a diagram to show an example of information related to DMRS port.

FIG. 7 is a diagram to show an example of information related to DMRS port.

FIG. 8 FIGS. 8A and 8B are diagrams to show examples of information related to DMRS port.

FIG. 9 is a diagram to show a receiver assumption of a scheduled UE (new UE).

FIG. 10 is a diagram to show an example of a schematic structure of a radio communication system according to one embodiment.

FIG. 11 is a diagram to show an example of a structure of a base station according to one embodiment.

FIG. 12 is a diagram to show an example of a structure of a user terminal according to one embodiment.

FIG. 13 is a diagram to show an example of a hardware structure of the base station and the user terminal according to one embodiment.

FIG. 14 is a diagram to show an example of a vehicle according to one embodiment.

### DESCRIPTION OF EMBODIMENTS

### Beam Management

In NR, a method of beam management is introduced. For example, for NR, forming (or using) beams in at least one of a base station and a UE has been under study.

Through application of beam forming (BF), it is expected that difficulty in securing coverage due to increase in carrier frequency be reduced, and radio wave propagation loss be reduced.

BF is, for example, a technique in which a beam (antenna directivity) is formed by controlling (also referred to as precoding) amplitude/phase of a signal that is transmitted or received from each element by using an ultra multi-element antenna. Note that Multiple Input Multiple Output (MIMO) using such an ultra multi-element antenna is also referred to as massive MIMO.

Both the transmission and reception sides may be controlled to perform beam sweeping and select an appropriate pair from a plurality of patterns of transmission and reception beam pair candidates. The pair of transmit beam and receive beam may be referred to as a beam pair and may be identified as a beam pair candidate index.

Note that, in beam management, a single beam is not used, and a plurality of levels of beam control, such as a rough beam and a fine beam, may be performed.

BF can be categorized into digital BF and analog BF. Digital BF and analog BF may be referred to as digital precoding and analog precoding, respectively.

Digital BF is, for example, a method in which precoding signal processing is performed on a baseband (for a digital signal). In this case, as many parallel processings, such as inverse fast Fourier transform (IFFT), digital to analog conversion (Digital to Analog Converter (DAC)), and Radio Frequency (RF), as the number of antenna ports (or RF chains) are required. At the same time, as many beams as the number of RF chains can be formed at any timing.

Analog BF is, for example, a method in which a phase shifter is used in RF. In analog BF, a plurality of beams cannot be formed at the same timing; however, a configuration thereof is easy and can be implemented at a low cost because it is only necessary that phase of RF signals be rotated.

Note that a hybrid BF configuration, which is a combination of digital BF and analog BF, can be implemented as well. In NR, introduction of massive MIMO has been under study. When forming of a great number of beams is intended to be performed by means of only digital BF, however, a circuit configuration costs much. Thus, use of the hybrid BF configuration is also assumed.

### TCI, Spatial Relation, QCL

For NR, control of reception processing (for example, at least one of reception, demapping, demodulation, and decoding) and transmission processing (for example, at least one of transmission, mapping, precoding, modulation, and coding) of at least one of a signal and a channel (which may be referred to as a signal/channel; hereinafter, in a similar manner, “A/B” may be interpreted as “at least one of A and B”) based on a transmission configuration indication state (TCI state) has been under study.

The TCI state may be a state applied to a downlink signal/channel. A state that corresponds to the TCI state applied to an uplink signal/channel may be expressed as spatial relation.

The TCI state is information related to quasi-co-location (QCL) of the signal/channel, and may be referred to as a spatial reception parameter, spatial relation information (SRI), or the like. The TCI state may be configured for the UE for each channel or for each signal.

QCL is an indicator indicating statistical properties of the signal/channel. For example, when a certain signal/channel and another signal/channel are in a relationship of QCL, it may be indicated that it is assumable that at least one of Doppler shift, a Doppler spread, an average delay, a delay spread, and a spatial parameter (for example, a spatial reception parameter (spatial Rx parameter)) is the same (the relationship of QCL is satisfied in at least one of these) between such a plurality of different signals/channels.

Note that the spatial reception parameter may correspond to a receive beam of the UE (for example, a receive analog beam), and the beam may be identified based on spatial QCL. The QCL (or at least one element in the relationship of QCL) in the present disclosure may be interpreted as sQCL (spatial QCL).

For the QCL, a plurality of types (QCL types) may be defined. For example, four QCL types A to D may be provided, which have different parameter(s) (or parameter set(s)) that can be assumed to be the same, and such parameter(s) (which may be referred to as QCL parameter(s)) are described below:
QCL type A: Doppler shift, Doppler spread, average delay, and delay spread
QCL type B: Doppler shift and Doppler spread
QCL type C: Doppler shift and Average delay
QCL type D: Spatial reception parameter

Types A to C may correspond to QCL information related to synchronization processing of at least one of time and frequency, and type D may correspond to QCL information related to beam control.

A case that the UE assumes that a certain control resource set (CORESET), channel, or reference signal is in a relationship of specific QCL (for example, QCL type D) with another CORESET, channel, or reference signal may be referred to as QCL assumption.

The UE may determine at least one of a transmit beam (Tx beam) and a receive beam (Rx beam) of the signal/channel, based on the TCI state or the QCL assumption of the signal/channel.

The TCI state may be, for example, information related to OCL between a channel as a target (or a reference signal (RS) for the channel) and another signal (for example, another downlink reference signal (DL-RS)). The TCI state may be configured (indicated) by higher layer signaling or physical layer signaling, or a combination of these.

In the present disclosure, the higher layer signaling may be, for example, any one or combinations of Radio Resource Control (RRC) signaling, Medium Access Control (MAC) signaling, broadcast information, and the like.

The MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

The physical layer signaling may be, for example, downlink control information (DCI).

A channel for which the TCI state is configured (indicated) may be, for example, at least one of a downlink shared channel (Physical Downlink Shared Channel (PDSCH)), a downlink control channel (Physical Downlink Control Channel (PDCCH)), an uplink shared channel (Physical Uplink Shared Channel (PUSCH)), and an uplink control channel (Physical Uplink Control Channel (PUCCH)).

The RS (DL-RS) to have a QCL relationship with the channel may be, for example, at least one of a synchronization signal block (SSB), a channel state information reference signal (CSI-RS), and a reference signal for measurement (Sounding Reference Signal (SRS)). Alternatively, the DL-RS may be a CSI-RS used for tracking (also referred to as a Tracking Reference Signal (TRS)), or a reference signal used for QCL detection (also referred to as a QRS).

The SSB is a signal block including at least one of a primary synchronization signal (PSS), a secondary synchronization signal (SSS), and a broadcast channel (Physical Broadcast Channel (PBCH)). The SSB may be referred to as an SS/PBCH block.

An information element of the TCI state (“TCI-state IE” of RRC) configured using higher layer signaling may include one or a plurality of pieces of QCL information (“QCL-Info”). The QCL information may include at least one of information related to the DL-RS to have a QCL relationship (DL-RS relation information) and information indicating a QCL type (QCL type information). The DL-RS relation information may include information such as an index of the DL-RS (for example, an SSB index, or a non-zero power CSI-RS (NZP CSI-RS) resource ID (Identifier)), an index of a cell in which the RS is located, and an index of a Bandwidth Part (BWP) in which the RS is located.

### Development of MIMO Technology and Beams

Incidentally, the MIMO technology has been used in a frequency band lower than 6 GHz, but it is studied that the MIMO technology is to be applied to a frequency band higher than 6 GHZ in the future.

Note that a frequency band lower than 6 GHZ may be referred to as sub-6, frequency range (FR) 1, or the like. The frequency band higher than 6 GHz may be referred to as above-6, FR2, millimeter wave (mmW), FR4, or the like.

The maximum number of MIMO layers is assumed to be limited by an antenna size.

Even in mmW, by use of higher-order MIMO and cooperation of a plurality of UEs, the degree of freedom and diversity of MIMO multiplexing are improved, and thus improvement in throughput is expected.

As described above, in a future radio communication system (for example, NR of Rel-17 or later versions), even in a high-frequency (for example, FR2), it is assumed that an operation (which may be referred to as a full digital operation) of using only a digital beam without using an analog beam is used or an operation of dominantly using a digital beam is used.

For example, in a case of full-digital operation, simultaneously applying orthogonal precoding (or orthogonal beams or digital beams) to a plurality of UEs, frequency use efficiency can be expected to be improved. If the digital beam cannot be appropriately applied, this increases interference between UEs, which leads to deterioration in communication quality (or reduction in cell capacity). Note that the term “orthogonal” in the present disclosure may be interpreted as “quasi-orthogonal.”

When the base station (which may be interpreted as a transmission/reception point (TRP), a panel, or the like) can transmit only one beam at a certain time, the base station switches beams for the UE to perform transmission and reception. When the base station can transmit a plurality of beams at a certain time, the base station can transmit and receive to and from a plurality of UEs by using different beams at the same time.

Even if the base station is of fully digital, as long as Rel-15 UEs exist, the Rel-15 UEs is required to be accommodated (supported).

### Port of Reference Signal

For orthogonalization of MIMO layers and the like, reference signals of a plurality of ports (for example, demodulation reference signals (DMRSs), CSI-RSs) are used.

For example, for single user MIMO (SU-MIMO), different DMRS ports/CSI-RS ports may be configured for each layer. For multi user MIMO (MU-MIMO), different DMRS ports/CSI-RS ports may be configured for each layer in one UE and for each UE.

Note that, when CSI-RS ports the number of which is larger than the number of layers used for data are used, a channel state more can be accurately measured based on the CSI-RSs, and it is expected that this contributes improvement of throughput.

In Rel-15 NR, a DMRS of a plurality of ports supports 8 ports at maximum in a case of type-1 DMRS (in other words, DMRS configuration type 1) and 12 ports at maximum in a case of type-2 DMRS (in other words, DMRS configuration type 2), by using frequency division multiplexing (FDM), frequency-domain orthogonal cover code (FD-OCC), time-domain OCC (TD-OCC), or the like.

In Rel-15 NR, a comb-shaped transmission frequency pattern (comb-shaped resource set) is used for the FDM. For the FD-OCC, a cyclic shift (CS) is used. The TD-OCC may be applied only to a double symbol DMRS.

The OCC of the present disclosure may be interpreted as an orthogonal code, orthogonalization, cyclic shift, or the like.

Note that the type of the DMRS may be referred to as a DMRS configuration type.

Among DMRSs, a DMRS applied with resource mapping in units of two continuous (adjacent) symbols may be referred to as a double-symbol DMRS, and a DMRS applied with resource mapping in units of one symbol may be referred to as a single-symbol DMRS.

Both types of DMRSs may be mapped to one or more symbols per slot depending on a length of a data channel. The DMRS mapped to a start position of a data symbol may be referred to as a front-loaded DMRS, and the DMRS additionally mapped to another position may be referred to as an additional DMRS.

In a case of DMRS configuration type 1 and single-symbol DMRS, Comb and CS may be used for orthogonalization. For example, up to four antenna ports (APs) may be supported by using two types of Comb and two types of CS (Comb2+2CS).

In a case of DMRS configuration type 1 and double-symbol DMRS, Comb, CS, and TD-OCC may be used for orthogonalization. For example, up to eight APs may be supported by using two types of Comb, two types of CS, and TD-OCC ({1, 1} and {1, −1}).

In a case of DMRS configuration type 2 and single-symbol DMRS, FD-OCC may be used for orthogonalization. For example, up to six APs may be supported by applying an orthogonal code (2-FD-OCC) to two resource elements (REs) adjacent to each other in the frequency direction.

In a case of DMRS configuration type 2 and double-symbol DMRS, the FD-OCC and the TD-OCC may be used for orthogonalization. For example, up to 12 APs may be supported by applying the orthogonal code (2-FD-OCC) to two REs adjacent to each other in the frequency direction and applying the TD-OCC ({1, 1} and {1, −1}) to two REs adjacent to each other in the time direction.

In Rel-15 NR, 32 ports at maximum are supported for CSI-RSs of a plurality of ports by using FDM, time division multiplexing (TDM), a frequency domain OCC, a time domain OCC, or the like. The similar method to that for the DMRS described above may be applied to orthogonalization of the CSI-RS.

A group of DMRS ports orthogonalized by the FD-OCC/TD-OCC as described above is also referred to as a code division multiplexing (CDM) group.

Different CDM groups are FDMed, and thus are orthogonal to each other. On the other hand, within the same CDM group, orthogonality of the applied OCCs may be lost due to channel variation or the like. In this case, when signals within the same CDM group are received with different received powers, a near-far resistant occurs, and orthogonality may not be secured.

Here, the TD-OCC/FD-OCC of the DMRS of Rel-15 NR is described. The DMRS mapped to a resource element (RE) may correspond to a sequence obtained by multiplying a DMRS sequence by an FD-OCC parameter (which may be referred to as a sequence element or the like) w_{f}(k′) and a TD-OCC parameter (which may be referred to as a sequence element or the like) wₜ (l′).

Each of the TD-OCC and the FD-OCC of the DMRS of Rel-15 NR correspond to an OCC with a sequence length (which may be referred to as an OCC length)=2. Therefore, possible values of k′ and l′ are both 0 and 1. By multiplying the FD-OCC in units of RE, the DMRSs of two ports can be multiplexed using the same time and frequency resources (2 REs). When both the FD-OCC and the TD-OCC are applied, DMRSs of four ports can be multiplexed using the same time and frequency resources (4 REs).

In the parameters for a PDSCH DMRS, DMRS ports (which may be referred to as antenna ports) 1000 to 1007 may be used for DMRS configuration type 1, and DMRS ports 1000 to 1011 may be used for DMRS configuration type 2.

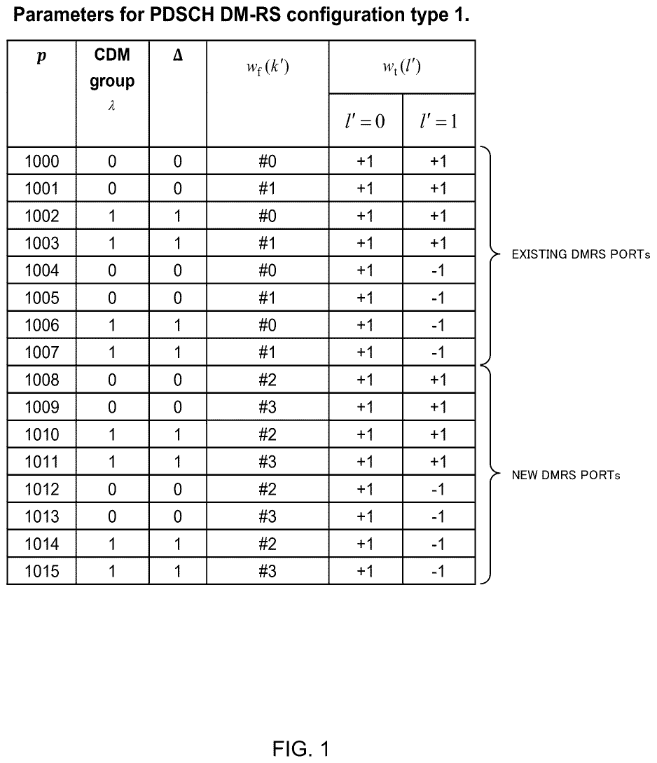

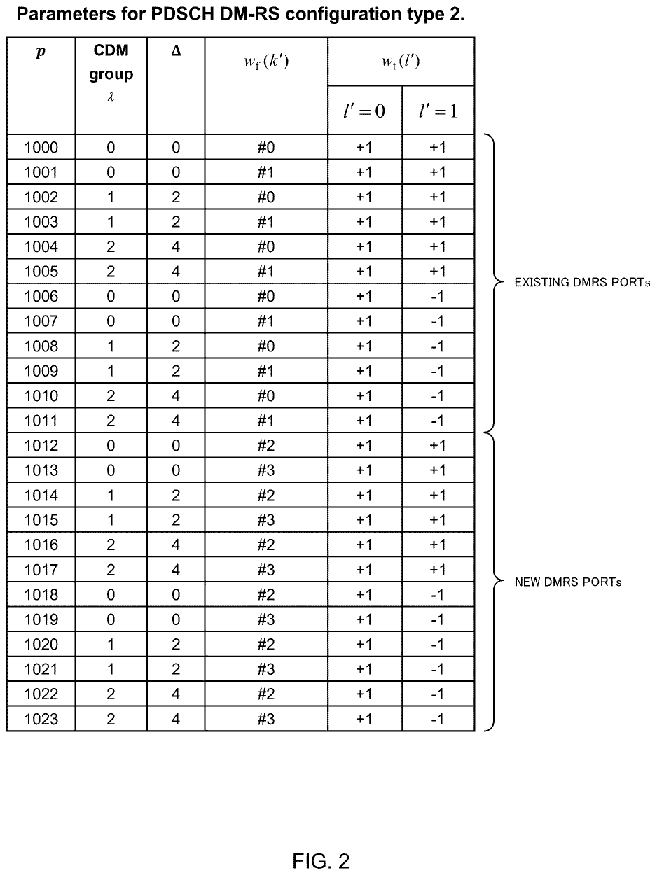

In two tables (association between antenna port number and parameter) corresponding to two respective DMRS configurations of type 1 and type 2 (for example, FIGS. 1 and 2 described below), p indicates the antenna port number, and A indicates a parameter for shifting (offsetting) the frequency resource.

For example, the antenna ports 1000 and 1001 are orthogonalized using the FD-OCC by applying {w_{f}(0), w_{f}(1)}={+1, +1} and {w_{f}(0), w_{f}(1)}={+1, −1}, respectively.

The antenna ports 1000 to 1001 and the antenna ports 1002 to 1003 (and the antenna ports 1004 to 1005 in the case of the type 2) are applied with different values of Δ, and thus FDM is applied to these antenna ports. Therefore, the antenna ports 1000 to 1003 (or 1000 to 1005) corresponding to the single-symbol DMRS are orthogonalized using the FD-OCC and FDM.

The type-1 antenna ports 1000 to 1003 and the antenna ports 1004 to 1007 are orthogonalized using the TD-OCC by applying {wₜ(0), wₜ(1)}={+1, +1} and {wₜ(0), wₜ(1)}={+1, −1}, respectively. Therefore, the antenna ports 1000 to 1007 (or 1000 to 1011) corresponding to the double-symbol DMRS are orthogonalized using the FD-OCC, the TD-OCC, and FDM.

In Rel. 15, the total number of DMRS ports in a single-symbol DMRS of (PDSCH DMRS) configuration type 1 is 2 (by comb/FDM)×2 (by FD OCC)=4 ports. In Rel. 15, the total number of DMRS ports in a double-symbol DMRS of (PDSCH DMRS) configuration type 1 is 2 (by comb/FDM)×2 (by FD OCC)×2 (by TD OCC)=8 ports.

In Rel. 15, the total number of DMRS ports in a single-symbol DMRS of (PDSCH DMRS) configuration type 2 is 3 (by FDM)×2 (by FD OCC)=6 ports. In Rel. 15, the total number of DMRS ports in a double-symbol DMRS of (PDSCH DMRS) configuration type 2 is 3 (by comb)×2 (by FD OCC)×2 (by TD OCC)=12 ports.

It is under study that defining a larger number of orthogonal DMRS ports for DL/UL MU-MIMO without increasing a DMRS overhead, doubling the maximum number of DMRS ports for both single-symbol DMRS and double-symbol DMRS.

The UE may select a new table (DMRS port table) for determining the DMRS port, based on a higher layer configuration. When the higher layer configures a new DMRS port (DMRS ports the number of which is greater than the existing number), the UE may select a new DMRS port table.

A new DMRS port table for DMRS configuration type 1 and a new DMRS port table for DMRS configuration type 2 may be defined. When the DMRS configuration type 1 and the higher layer parameter for the new DMRS port are configured, the UE may use the new DMRS port table for the DMRS configuration type 1, and when the DMRS configuration type 1 is configured and the higher layer parameter for the new DMRS port is not configured, the UE may use an existing DMRS port table for the DMRS configuration type 1 (DMRS port table defined in Rel. 15). When the DMRS configuration type 2 and the higher layer parameter for the new DMRS port are configured, the UE may use the new DMRS port table for the DMRS configuration type 2, and when the DMRS configuration type 2 is configured and the higher layer parameter for the new DMRS port is not configured, the UE may use an existing DMRS port table for the DMRS configuration type 2 (DMRS port table defined in Rel. 15).

Specifically, for example, the new DMRS port tables illustrated in FIGS. 1 and 2 may be defined. FIG. 1 shows an example of table 1 for DMRS configuration type 1. FIG. 2 shows an example of table 1 for DMRS configuration type 2. In the new DMRS port tables, entries (including at least one of CDM group, 4, FD OCC, and TD OCC) corresponding to existing DMRS port indices (1000 to 1007 for DMRS configuration type 1 and 1000 to 1011 for DMRS configuration type 2) are not changed. In the new DMRS port tables, entries for new DMRS port indices (1008 to 1015 for DMRS configuration type 1, and 1012 to 1023 for DMRS configuration type 2) are added. The added entries have the same contents as those of the existing DMRS port table except for w_{f}(k′) (i.e., CDM group, A, and TD OCC). These new DMRS port tables are merely examples, and the present embodiment is not limited thereto.

### Multiplexing of DMRS for Existing UE and DMRS for New UE

As described above, in addition to doubling the maximum number of DMRS ports, the following five options are under study.

### Option 1

Introduction of a new OCC having a length greater than the existing OCCs (e.g., 4 or 6).

In option 1, examples of items to be studied include a possibility of performance degradation in a case of large delay spread, a possibility of scheduling restriction, and backward compatibility.

### Option 2

Use of TD-OCC on non-continuous DMRS symbols (e.g., TD-OCC on front-loaded DMRS/additional DMRS).

In option 2, examples of items to be studied include a possibility of performance degradation in a case of high speed UE, a possibility of scheduling restriction (e.g., a method of applying frequency hopping), a possibility of DMRS configuration restriction (e.g., the number of additional DMRSs is restricted), backward compatibility.

### Option 3

Increase the number of CDM groups (e.g., increase the number of comb/FDM).

In option 3, examples of items to be studied include a possibility of performance degradation in a case of large delay spread and backward compatibility.

### Option 4

Reuse symbols of additional DMRS to increase orthogonal DMRS ports.

In option 4, examples of items to be studied include a possibility of performance degradation in a case of high speed UE, a possibility of DMRS configuration restriction (e.g., the number of additional DMRSs is restricted), and backward compatibility.

### Option 5

Use of TD-OCC on non-continuous DMRS symbols in combination with FD-OCC/FDM (reusing symbols of additional DMRS to improve channel estimation performance).

In option 5, examples of items to be studied include a possibility of performance degradation in a case of high speed UE, a possibility of scheduling restriction (e.g., a method of applying frequency hopping), a possibility of DMRS configuration restriction (e.g., the number of additional DMRSs is restricted), backward compatibility.

It is under study that a DMRS for the existing UE and a DMRS for a new UE are multiplexed within the same CDM group. Here, the existing UE may be a Rel-15/16/17 UE. The new UE may be a UE that uses a larger number of DMRS ports than the number of DMRS ports of the existing UE, may be a UE that uses a new OCC/DMRS, or may be a UE of Rel. 18 or later versions.

It is preferable to enable MU-MIMO over the existing UE and the new UE. In this case, it is important to have orthogonality between a new OCC and an existing OCC of Rel. 15.

The new OCC can be orthogonal to the existing OCC. Even when the existing OCC is a part of the new OCC, the new OCC can be orthogonal to the existing OCC. The new OCC may be longer than the existing OCC.

In order to maintain orthogonality, a receiver (base station/UE) is required to know the length of the OCC. For example, when an OCC having a length of 2 is applied, the receiver can decode the OCC by using two points (2 REs, a multiple of 2 points/REs) of a received signal. When an OCC having a length of 4 is multiplexed, the receiver needs to use four points (4 REs, multiple of 4 points/REs) of the received signal for decoding the OCC.

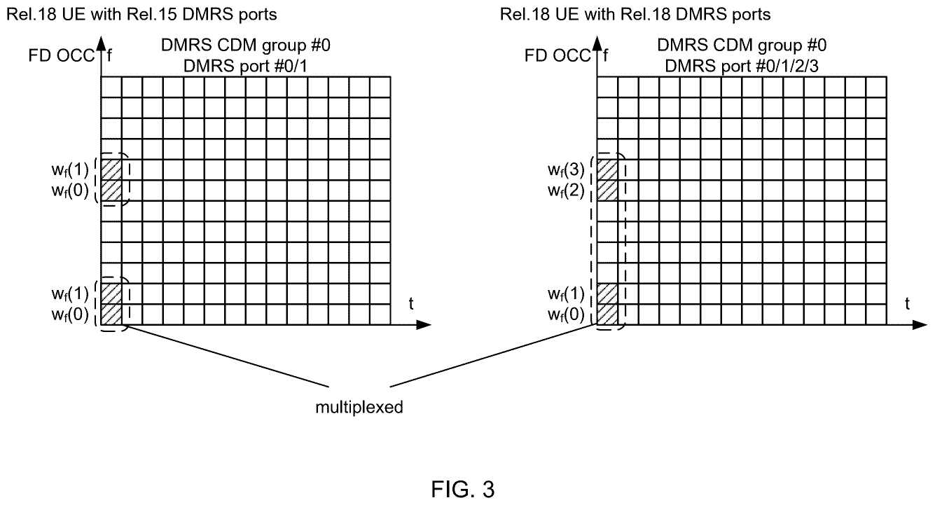

FIG. 3 shows an example of multiplexing of a DMRS for an existing UE and a DMRS for a new UE. In FIG. 3, a DMRS applied with an existing FD OCC of length of 2 is transmitted in four RES, and a DMRS applied with a new FD OCC of length of 4 is transmitted in the four REs, whereby the DMRS for the existing UE (existing DMRS) and the DMRS for the new UE (new DMRS) are multiplexed. When all multiplexed OCCs have the length of 2, the receiver uses received signals of two REs for decoding the OCCs. In this example, to maintain orthogonality, the receiver uses received signals of four REs for decoding the OCCs.

For DMRS of PDSCH, the UE may use received signal of M REs for decoding the OCCs. M is a length of the new OCC. Information related to the length of the OCC may be reported by higher layer signaling. The existing UE may always assume all signals/REs in one PRB. In this case, the existing UE can decode the new OCC. The existing UE may not always assume all signals/REs in one PRB. In this case, the existing UE cannot decode the new OCC.

As described above, there is a case where the existing UE cannot decode the DMRS port multiplexed by the new OCC (case 1).

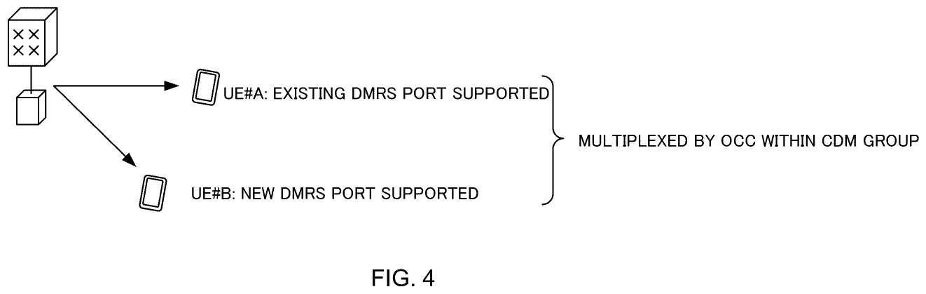

FIG. 4 shows an example of a scenario in which a DMRS for the existing UE and a DMRS for the new UE are multiplexed. In FIG. 4, it is assumed that a UE # A is a new UE for which an existing DMRS port is configured/indicated, and a UE # B is a new UE for which a new DMRS port is configured/indicated.

When the UE # A is the existing UE, DMRS ports with OCCs having different lengths (new DMRS ports with an OCC having a length of 4 or more), in other words, DMRS ports of the UE # B, cannot be multiplexed. On the other hand, as illustrated in FIG. 4, in a case that the UE # A is the new UE, even when an existing DMRS port is configured/indicated for the UE # A, the DMRS port of the UE # B can be multiplexed.

In this case, a problem is that, based on which of existing UE behavior or new UE behavior, the UE # A demodulates the existing DMRS port. In other words, there is a case where the new UE demodulates the existing DMRS port (case 2).

Problems includes how to increase (expand) the total number of DMRS ports while suppressing the overhead of DMRS, and when the total number of DMRS ports is increased (expanded), based on which of the existing UE the existing UE behavior or the new UE behavior, the new UE demodulates the OCC (DMRS port). However, studies on such problems have not been advanced yet. If an appropriate DMRS ports are not available, communication throughput/communication quality may be degraded.

Thus, the inventors of the present invention came up with the idea of a method of configuring/indicating a DMRS port for a new UE.

Embodiments according to the present disclosure will be described in detail with reference to the drawings as follows. The embodiments (e.g., cases) to be described below may each be employed individually, or at least two of the embodiments may be employed in combination.

In the present disclosure, “A/B” and “at least one of A and B” may be interchangeably interpreted. In the present disclosure, “A/B/C” may be interchangeably interpreted as “at least one of A, B, and C”.

In the present disclosure, activate, deactivate, indicate, select, configure, update, determine, and the like may be interchangeably interpreted. In the present disclosure, “support,” “control,” “controllable,” “operate,” “operable,” and the like may be interchangeably interpreted.

In the present disclosure, radio resource control (RRC), an RRC parameter, an RRC message, a higher layer parameter, an information element (IE), a configuration, and the like may be interchangeably interpreted. In the present disclosure, a Medium Access Control control element (MAC Control Element (CE)), an update command, an activation/deactivation command, and the like may be interchangeably interpreted.

In the present disclosure, the higher layer signaling may be, for example, any one or combinations of Radio Resource Control (RRC) signaling, Medium Access Control (MAC) signaling, broadcast information, and the like.

In the present disclosure, the MAC signaling may use, for example, a MAC control element (MAC CE), a MAC Protocol Data Unit (PDU), or the like. The broadcast information may be, for example, a master information block (MIB), a system information block (SIB), minimum system information (Remaining Minimum System Information (RMSI)), other system information (OSI), or the like.

In the present disclosure, the physical layer signaling may be, for example, downlink control information (DCI), uplink control information (UCI), or the like.

In the present disclosure, an index, an identifier (ID), an indicator, a resource ID, and the like may be interchangeably interpreted. In the present disclosure, a sequence, a list, a set, a group, a cluster, a subset, and the like may be interchangeably interpreted.

In the present disclosure, a panel, a UE panel, a panel group, a beam, a beam group, a precoder, an Uplink (UL) transmission entity, a transmission/reception point (TRP), a base station, spatial relation information (SRI), a spatial relation, an SRS resource indicator (SRI), a control resource set (CORESET), a Physical Downlink Shared Channel (PDSCH), a codeword (CW), a transport block (TB), a reference signal (RS), an antenna port (for example, a demodulation reference signal (DMRS) port), an antenna port group (for example, a DMRS port group), a group (for example, a spatial relation group, a code division multiplexing (CDM) group, a reference signal group, a CORESET group, a Physical Uplink Control Channel (PUCCH) group, a PUCCH resource group), a resource (for example, a reference signal resource, an SRS resource), a resource set (for example, a reference signal resource set), a CORESET pool, a downlink Transmission Configuration Indication state (TCI state) (DL TCI state), an uplink TCI state (UL TCI state), a unified TCI state, a common TCI state, quasi-co-location (QCL), QCL assumption, and the like may be interchangeably interpreted.

In the present disclosure, time domain resource allocation and time domain resource assignment may be interchangeably interpreted.

### Radio Communication Method

### First Embodiment

A first embodiment relates to indication of DMRS ports for a new UE and a decoding operation of a UE. In the present disclosure, an existing DMRS port, a port defined in an existing DMRS port table, a DMRS port having an index within a range of existing DMRS port indices, and a DMRS port associated with an OCC of length of 2 may be interchangeably interpreted. In the present disclosure, a new DMRS port, an extended DMRS port, a port not defined in an existing DMRS port table, a DMRS port having an index outside a range of existing DMRS port indices, and a DMRS port associated with an OCC longer than 2 may be interchangeably interpreted. In the present disclosure, an existing DMRS, a DMRS applied with an OCC of length of 2, and a DMRS using an existing DMRS port may be interchangeably interpreted. In the present disclosure, a new DMRS, a DMRS applied with an OCC longer than 2, and a DMRS using a new DMRS port may be interchangeably interpreted. In the present disclosure, existing UE behavior, a Rel-15/16/17 DMRS receiving operation, a decoding operation of an OCC of length of 2, and an existing receiver may be interchangeably interpreted. In the present disclosure, new UE behavior, a receiving operation of a DMRS of Rel. 18 or later versions, a decoding operation of an OCC longer than 2, and an advanced receiver may be interchangeably interpreted. The OCC applied to the new DMRS may have a length of 4 or 6, or may have a length of another number greater than 2.

### Embodiment 1.1

As described in FIG. 3, there is a case where a DMRS applied with an existing FD OCC of length of 2 is transmitted to the UE in four REs, and a DMRS applied with a new FD OCC of length of 4 is transmitted in the four RES, whereby the DMRS for the existing UE (existing DMRS) and the DMRS for the new UE (new DMRS) are multiplexed. In this case, the new UE needs to be configured/indicated whether to perform any of the operations of decoding the existing DMRS and decoding the new DMRS.

The new UE may be configured/indicated with information related to a DMRS port of another UE (co-scheduled UE) scheduled for the same symbol as the new UE.

The new UE may be configured/indicated whether the new DMRS port is used/allocated to another UE (co-scheduled UE) having a different DMRS port index within the same CDM group or in different CDM groups.

The UE indicated with the new DMRS port indices (1008 to 1015 in a case of type 1 and 101 to 1023 in a case of type 2) can decode the new DMRS port (new OCC) in any case, and thus the UE need not be configured/indicated (may not be configured/indicated) the information related to the above-described DMRS port (information indicating whether the new DMRS port is used/allocated).

On the other hand, the UE indicated with the existing DMRS port indices (1000 to 1007 in a case of type 1, and 1000 to 1012 in a case of type 2) need not decode a received signal by assuming an OCC length of a new DMRS port (new OCC) when the new DMRS port (new OCC) within the same CDM group is not allocated to another UE for multiplexing (i.e., it is sufficient that the UE decodes a received signal taking only the existing DMRS port indices allocated to the UE (scheduled UE) into consideration). On the other hand, a UE indicated with the existing DMRS port indices (1000 to 1007 in the case of type 1, and 1000 to 1012 in the case of type 2) need to decode a received signal by assuming the OCC length of the new DMRS port (new OCC) when the new DMRS port (new OCC) within the same CDM group is allocated to another UE for multiplexing, to appropriately decode a corresponding signal. Therefore, the above-described information (information indicating whether the new DMRS port is used/allocated) need to be configured/indicated.
In this case, when a DMRS port of another UE (co-scheduled UE) scheduled in the same symbol as the UE is configured/indicated to the UE, the UE decodes the OCC by assuming (applying) new UE behavior even when the indicated DMRS port is an existing DMRS port index. Here, the DMRS port of such another UE (co-scheduled UE) may be in the same CDM group as the DMRS port/new DMRS port (new OCC) of the UE (scheduled UE).
Otherwise, there is no scheduling restriction. In other words, the UE can decode the OCC on the assumption of the existing UE behavior.

Here, the UE behavior for decoding the DMRS port index will be described. The existing UE behavior may be to decode the OCC assuming that the length of the OCC is 2 (assuming that the length of the OCC for decoding the OCC is 2). The new UE behavior may be to decode the OCC assuming that the length of the OCC is 4 or more (assuming the length of the OCC for decoding the OCC is 4).

In the present disclosure, decoding an OCC, decoding a DMRS, decoding a DMRS, decoding a PDSCH, and the like may be interchangeably interpreted.

The information related to the DMRS port described above (information indicating whether a new DMRS port is used/allocated) may include at least one of the following:
whether there is another UE (co-scheduled UE) scheduled in the same symbol;
DMRS port (index) of the scheduled UE;
CDM group of scheduled UEs;
existing DMRS configuration or new DMRS configuration (type) of another UE (co-scheduled UE) scheduled on the same symbol;
existing DMRS configuration or new DMRS configuration (type) of another UE (co-scheduled UE) to which a different DMRS port of the Same CDM group of the same symbol is allocated; and
UE capability related to DMRS decoding of scheduled UE.
   Note that the existing DMRS configuration (type) may be interpreted as an existing DMRS port number, and the new DMRS configuration (type) may be interpreted as a new DMRS port number.

The information related to the DMRS port described above may be, for example, any of tables illustrated in FIGS. 1, 2, 5, . . . , 8.

The information related to the DMRS ports may be signaled to the UE by RRC/MAC/DCI. Higher layer signaling may be defined to configure the new UE behavior to decode the OCC for DMRS of PDSCH. For example, when not existing any other UE scheduled in the same symbol is signaled to the UE by RRC, the UE can recognize that the DMRS is not multiplexed in MU-MIMO. When the DMRS port of another UE being the existing DMRS port is signaled by RRC, the UE attempts to decode the DMRS by applying the existing UE behavior. In other words, the UE Behavior (existing UE Behavior/new UE behavior) may be configured by higher layer signaling. Regarding whether to “exist any other UE scheduled in the same symbol”, a case may be assumed where the same CDM group as that of the DMRS port of the UE (scheduled UE)/new DMRS port (new OCC) is applied to the DMRS port of another UE (co-scheduled UE).

Reporting the information related to the DMRS port by using DCI enables explicit indication of the UE behavior for each scheduling.

The UE capability may be defined as follows:
support a new DMRS port (i.e., whether a new DMRS port indices (1008 to 1015 in the case of type 1 or 101 to 1023 in the case of type 2) can be indicated);
support new UE behavior of decoding an OCC for DMRS of PDSCH (i.e., whether a new DMRS port index can be indicated to another UE (co-scheduled UE) scheduled within the same CDM group); and
a plurality of decoding schemes can be attempted for one PDSCH.

The UE capability described above may be defined as a UE capability that is different between the PDSCH and the PUSCH.

A UE supporting the new DMRS port may assume that it is required to support the new UE behavior of decoding the OCC.

As a new UE capability, whether the UE can attempt the plurality of decoding schemes for one PDSCH (DMRS port) may be defined. For example, when the UE is configured with the information related to a DMRS port of another UE (co-scheduled UE) by RRC, the UE may be scheduled as SU or MU for each PDSCH (DMRS port). Thus, the UE is preferably able to attempt the plurality of decoding schemes. Even when there is no configuration of another UE (co-scheduled UE), the UE may attempt a plurality of decoding schemes for one PDSCH.

### Embodiment 1.2

Embodiment 1.2 relates to indication of the information related to DMRS port, and describes a case in which a DMRS port of another UE (co-scheduled UE) scheduled on the same symbol as a scheduled UE (new UE, target UE) needs to be indicated. The DCI for scheduling the PDSCH/PUSCH may include an antenna port field and indicate the information related to DMRS port according to a value of the antenna port field.

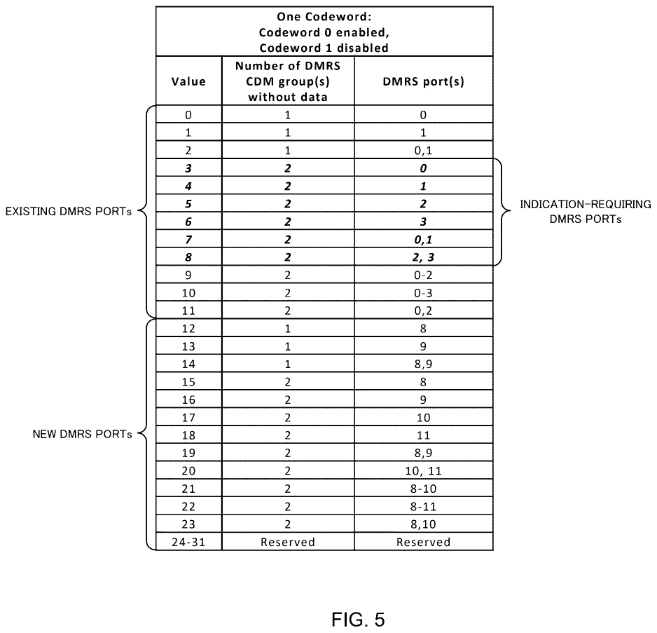

FIGS. 5 to 8 are diagrams to show examples of the information related to DMRS port. FIGS. 5 to 8 illustrate associations (new antenna port tables) between a value of the antenna port field, the number of CDM groups of DMRSs including no data, and the number of DMRS ports. For example, in FIG. 5, when the value of the antenna port field indicates 3 to 8 in the existing DMRS port in which the number of CDM groups is 2, it is necessary to indicate the DMRS port of another UE (co-scheduled UE). This is because, in this case, the scheduled UE needs to decode the OCC by applying either the existing UE behavior or the new UE behavior. When the scheduled UE is indicated with a DMRS port of another UE, whether to apply the existing UE behavior or the new UE behavior may be indicated by higher layer signaling.

In another case, for example, when the value of the antenna port field is 0 to 2, the number of CDM groups of DMRSs including no data is 1. Thus, another CDM group is used for data transmission. Therefore, the DMRS of the scheduled UE is not CDMed with the DMRS of another UE, and there is no need to indicate the DMRS port of such another UE (co-scheduled UE). In this case, the scheduled UE may decode the OCC by assuming the existing UE behavior. When the value of the antenna port field is 9 to 11, the indicated DMRS port has already used a plurality of CDM groups. Therefore, the DMRS of the scheduled UE is not CDMed with the DMRS of another UE, and there is no need to indicate the DMRS port of such another UE (co-scheduled UE). In this case, the scheduled UE may decode the OCC by assuming the existing UE behavior. When the value of the antenna port field is 12 to 23, the new DMRS port is indicated. In this case, the scheduled UE decodes the OCC by assuming the new UE behavior. Therefore, there is no need to indicate the DMRS port of such another UE (co-scheduled UE).

Thus, when the new DMRS port is indicated to the scheduled UE, the scheduled UE decodes the OCC by applying the new UE behavior. Therefore, explicit RRC signaling for indicating the DMRS port of another UE (co-scheduled UE) is not required.

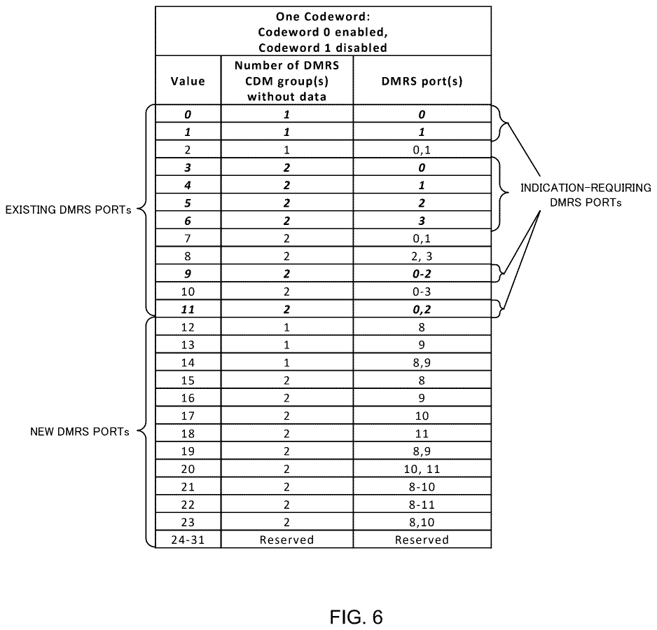

As in a variation illustrated in FIG. 6, when the value of the antenna port field is 0, 1, 3 to 6, 9, and 11, to the UE, the DMRS port of another UE (co-scheduled UE) may be indicated.

Which of the existing UE behavior and the new UE behavior is applied may be indicated by the DCI. For example, a new DCI field may be introduced, and the existing UE behavior may be applied when the DCI field is 0, and the new UE behavior may be applied when the DCI field is 1.

By introducing the above-described new DCI field, the indication of the existing DMRS ports (using a subset of the existing DMRS ports) and the indication of the new DMRS ports (using a subset of the new DMRS ports) may be dynamically switched. For example, in each of FIGS. 5 to 8, switching between the existing DMRS port and the new DMRS port may be indicated by DCI. This enables flexible control of the indication of the existing DMRS port and the indication of the new DMRS port.

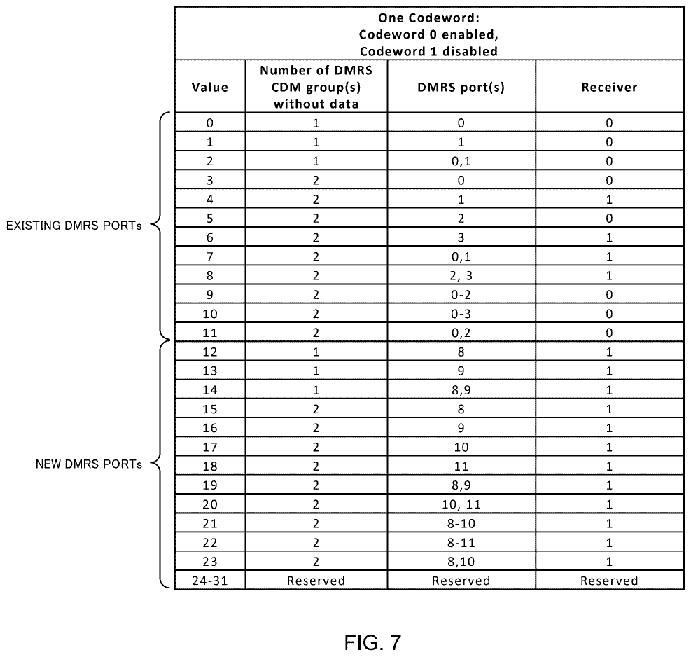

Alternatively, as illustrated in FIG. 7, information (new antenna port table) for further associating which of the existing UE behavior and the new UE behavior is applied with the existing DCI field (for example, antenna port field) may be defined in specifications. For example, a value {0, 1} of ‘receiver’ may be associated with a value of the antenna port field, and the existing UE behavior may be applied when the value of ‘receiver’ is 0, and the new UE behavior may be applied when the value of ‘receiver’is 1.

The first embodiment is also applicable to a case where the new DMRS port is not configured (a case where use of only the existing DMRS port is configured). In this case, higher layer signaling (RRC) or physical layer signaling (DCI) is required to indicate either the existing UE behavior or the new UE behavior.

When the UE is not configured/indicated to apply the new UE behavior, the UE may assume that the new DMRS port index is not associated with PDSCH transmission to another UE at least within the same CDM group.

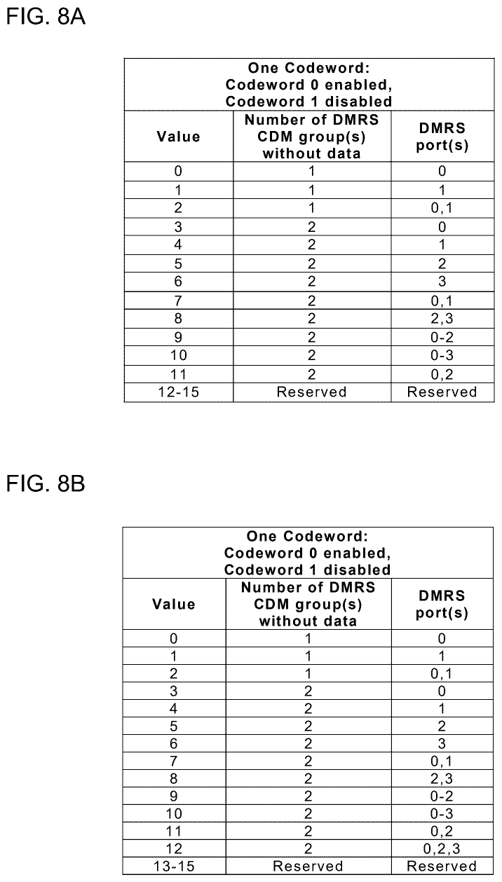

FIGS. 8A and 8B are diagrams illustrating antenna ports when the new DMRS port is not configured/indicated. For example, when the value of the antenna port field is 0 to 2, the number of CDM groups of DMRSs including no data is 1. In this case, another CDM group is used for data transmission (the DMRS of the scheduled UE is not CDMed with the DMRS of another UE, i.e., there is no UE to which MU-MIMO is applied). When the value of the antenna port field is 9 to 11 (FIG. 8A) or 9 to 12 (FIG. 8B), the indicated DMRS port has already used a plurality of CDM groups (the DMRS of the scheduled UE is not CDMed with the DMRS of another UE, i.e., there is no UE to which MU-MIMO is applied).

According to the first embodiment described above, the DMRS can be appropriately decoded regardless of types of the DMRS (whether the DMRS is the existing DMRS or the new DMRS). The new UE can perform an appropriate operation according to the type of the DMRS. For example, by performing the existing UE behavior for the existing DMRS by the new UE, the load/power consumption of the new UE can be suppressed.

### Second Embodiment

The second embodiment relates to the existing UE behavior and the new UE behavior.

### Embodiment 2.1

Embodiment 2.1 relates to scheduling restrictions between an existing UE and a new UE.

A scheduling restriction of MU-MIMO is required between an existing UE and a new UE. The scheduling restriction may be not to allow the use of a DMRS port of another UE (another DMRS port) scheduled in the same symbol as the DMRS port of a certain UE.

Here, the existing UE may be a UE of Rel. 15/16/17, or may be a UE that does not support UE behavior of Rel. 18/a DMRS port of Rel. 18. The new UE may be a UE of Rel. 18 or a UE of later versions (latest), and may be a UE supporting the UE behavior of Rel. 18/the DMRS port of Rel. 18.

Multiplexing of DMRS between the existing UE and the new UE may be allowed only between DMRS ports across different CDM groups. Different CDM groups are FDMed, and thus no interference occurs between the different CDM groups.

Multiplexing of DMRS between the existing UE and the new UE may not be allowed regardless of the same/different CDM groups. Frequency following property is not perfect, and thus some interference may occur between different CDM groups.

Note that the present disclosure is applicable to a PDSCH. For example, a base station that receives the PUSCH knows the length of the multiplexed OCCs, and thus the above-described scheduling restriction may not be applied. On the other hand, the present disclosure is not limited to the PDSCH, and is also applicable to a PUSCH.

### Embodiment 2.2

Embodiment 2.2 relates to UE behavior.

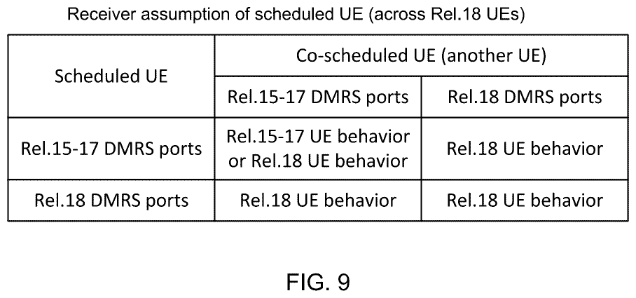

FIG. 9 is a diagram to show a receiver assumption of a scheduled UE (new UE). According to FIG. 9, when at least one of multiplexed DMRS ports is a new DMRS port (DMRS port of Rel. 18), it is required to apply new UE behavior (UE behavior of Rel. 18).

For example, when a scheduled UE is indicated with an existing DMRS port and another UE (UE scheduled in the same symbol (co-scheduled UE)) is indicated with an existing DMRS port, the scheduled UE applies existing UE behavior (UE behavior of Rel. 15 to Rel. 17) or new UE behavior.

When the scheduled UE is indicated with the existing DMRS port and another UE is indicated with the new DMRS port, the scheduled UE applies the new UE behavior.

When the scheduled UE is indicated with a new DMRS port and another UE is indicated with the existing DMRS port, the scheduled UE applies the new UE behavior.

When the scheduled UE is indicated with the new DMRS port and another UE is indicated with the new DMRS port, the scheduled UE applies the new UE behavior.

For the UE to which the existing UE behavior is applied, the existing MU-MIMO scheduling restriction is required to be applied. In other words, at least within a certain CDM group, such UE (UE to which the existing UE behavior is applied) is not to be multiplexed with the new DMRS port of another UE.

For the UE to which the new UE behavior is applied, the scheduling restriction of the existing MU-MIMO is to be enforced, and the following cases are allowed.
(1) Such UE (UE to which the new UE behavior is applied) can multiplex the new DMRS port of another UE within the same CDM group or between different CDM groups.
(2) Such UE (UE to which the new UE behavior is applied) can multiplex the existing DMRS port of another UE assuming the new UE behavior within the same CDM group or between different CDM groups.

In other words, the above-described scheduling restriction is applicable regardless of whether the DMRS port indicated to the scheduling UE is the existing DMRS port or the new DMRS port.

According to the second embodiment described above, appropriate UE behavior can be selected.

### Supplements

### Report of Information to UE

Notification of any information to a UE (from a network (NW) (for example, a base station (BS)) ) (in other words, reception of any information in the UE from the BS) may be performed by using physical layer signaling (for example, DCI), higher layer signaling (for example, RRC signaling, MAC CE), or a specific signal/channel (for example, a PDCCH, a PDSCH, a reference signal), or a combination of these.

When the notification is performed by a MAC CE, the MAC CE may be identified by a new logical channel ID (LCID) not defined in an existing standard being included in a MAC subheader.

When the notification is performed by DCI, the notification may be performed by a specific field of the DCI, a radio network temporary identifier (RNTI) used for scrambling of cyclic redundancy check (CRC) bits included in the DCI, the format of the DCI, or the like.

Notification of any information to a UE in the above-described embodiments may be performed periodically, semi-persistently, or aperiodically.

### Report of Information From UE

Notification of any information from a UE (to an NW) (in other words, transmission/reporting of any information in the UE to the BS) in the above-described embodiments may be performed by using physical layer signaling (for example, UCI), higher layer signaling (for example, RRC signaling, MAC CE), or a specific signal/channel (for example, a PUCCH, a PUSCH, a PRACH, a reference signal), or a combination of these.

When the notification is performed by a MAC CE, the MAC CE may be identified by a new LCID not defined in an existing standard being included in a MAC subheader.

When the notification is performed by UCI, the notification may be transmitted by using a PUCCH or a PUSCH.

Notification of any information from a UE in the above-described embodiments may be performed periodically, semi-persistently, or aperiodically.

### Application of Each Embodiment

At least one of the above-described embodiments may be applied when a specific condition is satisfied. The specific condition may be defined in a standard, or the UE/BS may be notified of the condition by using higher layer signaling/physical layer signaling.

At least one of the above-described embodiments may be applied only to a UE that has reported a specific UE capability or that supports the specific UE capability.

The specific UE capability may indicate at least one of the following:
supporting of specific processing/operation/control/information for at least one of the embodiments above
supporting of the new DMRS port
supporting of the new UE behavior to decode the OCC for DMRS of PDSCH
a plurality of decoding schemes can be attempted for one PDSCH

The specific UE capability may be a capability applied over all the frequencies (in common irrespective of frequency), a capability for each frequency (for example, one of or a combination of cell, band, band combination, BWP, component carrier, and the like), a capability for each frequency range (for example, Frequency Range 1 (FR1), FR2, FR3, FR4, FR5, FR2-1, and FR2-2), a capability for each subcarrier spacing (SCS), or a capability for each Feature Set (FS) or Feature Set Per Component-carrier (FSPC).

The specific UE capability may be a capability applied for all duplex schemes (in common irrespective of duplex scheme) or a capability for each duplex scheme (for example, time division duplex (TDD), frequency division duplex (FDD)).

At least one of the above-described embodiments may be applied when specific information related to the above-described embodiment (or carrying out the operation of the above-described embodiment) is configured/activated/triggered for a UE by higher layer signaling/physical layer signaling. For example, the specific information may be information indicating enabling . . . , any RRC parameter for a specific release (for example, Rel. 18/19), or the like.

When the UE does not support at least one of the specific UE capabilities above or is not configured with the specific information, operation of Rel. 15/16 may be applied, for example.

### SUPPLEMENTARY NOTE

Regarding one embodiment of the present disclosure, the following supplementary notes of the invention will be given.

### Supplementary Note 1

A terminal including:
a receiving section that receives information related to an extended demodulation reference signal (DMRS) port; and
a control section that assumes, based on the information related to the extended DMRS port, that a length of a second orthogonal cover code for decoding the DMRS is more than a length of a first orthogonal cover code.

### Supplementary Note 2

The terminal according to supplementary note 1, wherein the information related to the extended DMRS port includes information whether another terminal scheduled by a same symbol is present.

### Supplementary Note 3

The terminal according to supplementary note 1 or 2, wherein the receiving section receives the information related to the extended DMRS port by using higher layer signaling or downlink control information.

### Supplementary Note 4

The terminal according to any one of supplementary notes 1 to 3, further comprising a transmitting section that reports capability information of supporting operation of assuming that the length of the second orthogonal cover code is more than the length of the first orthogonal cover code.

### Radio Communication System

Hereinafter, a structure of a radio communication system according to one embodiment of the present disclosure will be described. In this radio communication system, the radio communication method according to each embodiment of the present disclosure described above may be used alone or may be used in combination for communication.

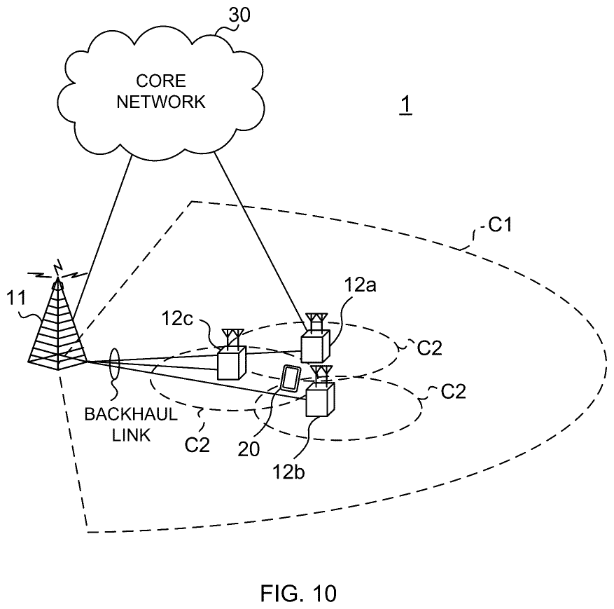

FIG. 10 is a diagram to show an example of a schematic structure of the radio communication system according to one embodiment. The radio communication system 1 (which may be simply referred to as a system 1) may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATS). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCS).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHZ), and FR2 may be a frequency band which is higher than 24 GHZ (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The core network 30 may include, for example, network functions (NF) such as a User Plane Function (UPF), an Access and Mobility Management Function (AMF), a Session Management Function (SMF), Unified Data Management (UDM), an ApplicationFunction (AF), a Data Network (DN), a Location Management Function (LMF), and Operation, Administration, and Maintenance (Management) (OAM). Note that a plurality of functions may be provided by one network node. Communication with an external network (for example, the Internet) may be performed via the DN.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-S-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### Base Station

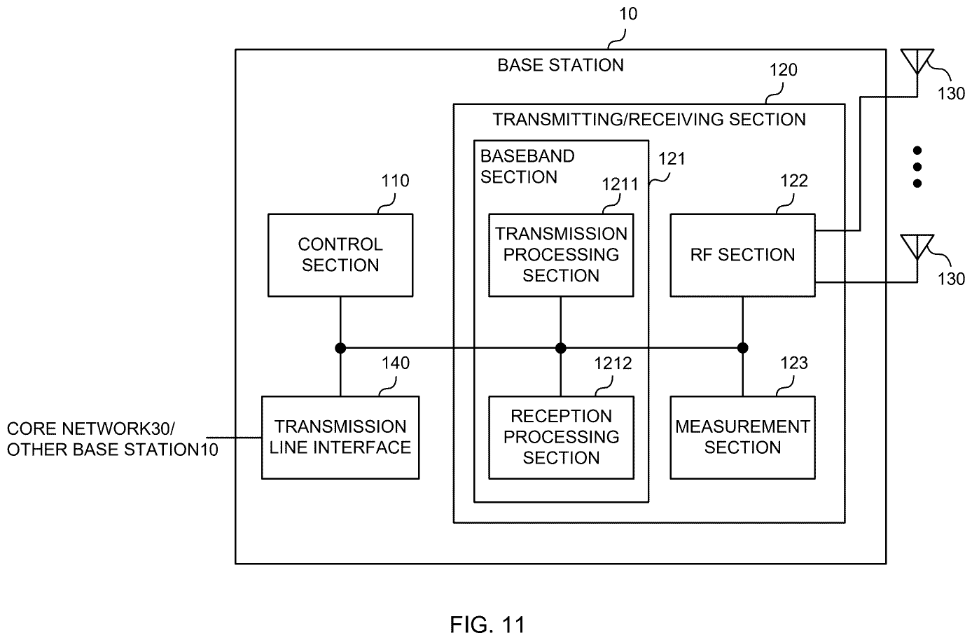

FIG. 11 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus (e.g., a network node providing an NF) included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

Note that the transmitting/receiving section 120 may transmit information related to a port of demodulation reference signal (DMRS).

The control section 110 may assume, based on the information, that a length of an orthogonal cover code for decoding the DMRS is more than 2.

### User Terminal

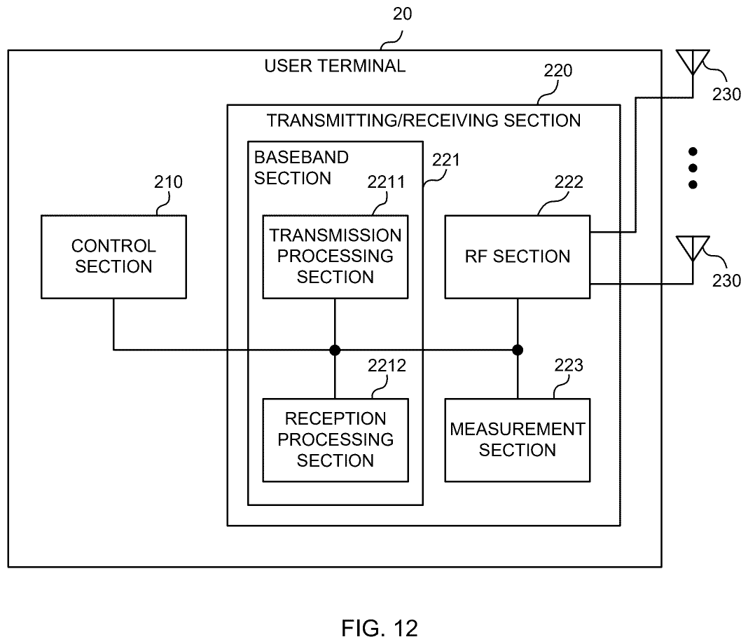

FIG. 12 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission processing.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

Note that the transmitting/receiving section 220 may receive information related to a port of demodulation reference signal (DMRS). Note that the information may include information whether another terminal scheduled by a same symbol as the DMRS is present. The transmitting/receiving section 220 may receive the information by using at least one of higher layer signaling and downlink control information. The transmitting/receiving section 220 may report capability information of supporting operation of assuming that the length of the orthogonal cover code is more than 2.

The control section 210 may assume, based on the information, that a length of an orthogonal cover code for decoding the DMRS is more than 2.

### Hardware Structure

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate apparatuses (for example, via wire, wireless, or the like) and using these apparatuses. The functional blocks may be implemented by combining software into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but functions are by no means limited to these. For example, a functional block (component) to implement a function of transmission may be referred to as a “transmitting section (transmitting unit)”, a “transmitter”, or the like. The method for implementing each component is not particularly limited as described above.

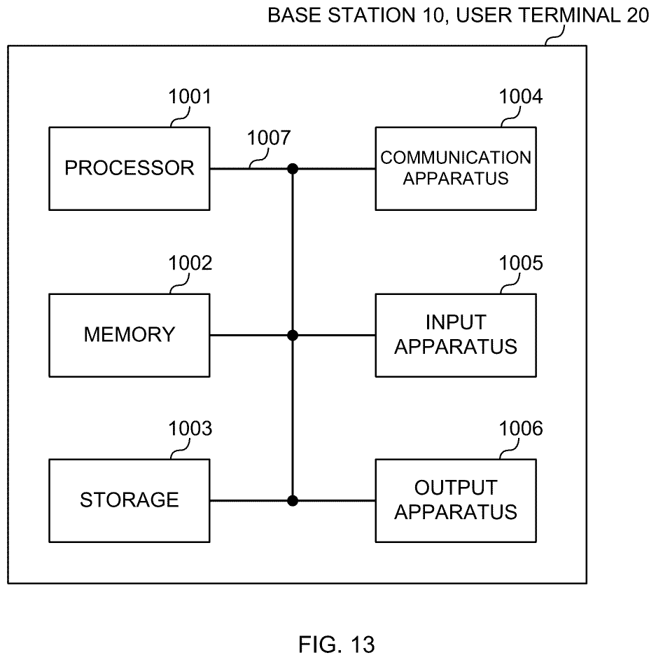

For example, a base station, a user terminal, and so on according to one embodiment of the present disclosure may function as a computer that executes the processes of the radio communication method of the present disclosure. FIG. 13 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably used. The hardware structure of the base station 10 and the user terminal 20 may be configured to include one or more of apparatuses shown in the drawings, or may be configured not to include part of apparatuses.

For example, although one processor 1001 is shown in the drawings, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminal 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least a part of the control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least a part of the operations explained in the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register”, a “cache”, a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “auxiliary storage apparatus”.

The communication apparatus 1004 is hardware (transmitting/receiving device) for allowing inter-computer communication via at least one of wired and wireless networks, and may be referred to as, for example, a “network device”, a “network controller”, a “network card”, a “communication module”, and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the transmitting/receiving section 120 (220), the transmitting/receiving antenna 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor or the like). The output apparatus 1006 is an output device that allows sending output to the outside (for example, a display, a speaker, a Light Emitting Diode (LED) lamp or the like). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between apparatuses.

Also, the base station 10 and the user terminal 20 may be structured to include hardware such as a microprocessor, a Digital Signal Processor (DSP), an Application Specific Integrated Circuit (ASIC), a Programmable Logic Device (PLD), a Field Programmable Gate Array (FPGA), and so on, and a part or all of the functional blocks may be implemented by the hardware. For example, the processor 1001 may be implemented with at least one of these pieces of hardware.

### Variations

It should be noted that a term used in the present disclosure and a term required for understanding of the present disclosure may be replaced by a term having the same or similar meaning. For example, a channel, a symbol, and a signal (or signaling) may be interchangeably used. Further, a signal may be a message. A reference signal may be abbreviated as an RS, and may be referred to as a pilot, a pilot signal or the like, depending on which standard applies. Furthermore, a component carrier (CC) may be referred to as a cell, a frequency carrier, a carrier frequency and so on.

A radio frame may be constituted of one or a plurality of periods (frames) in the time domain. Each of one or a plurality of periods (frames) constituting a radio frame may be referred to as a “subframe”. Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot”. A mini-slot may be constituted of symbols in number less than the slot. A PDSCH (or PUSCH) transmitted in a time unit larger than a mini-slot may be referred to as “PDSCH (PUSCH) mapping type A”. A PDSCH (or PUSCH) transmitted using a mini-slot may be referred to as “PDSCH (PUSCH) mapping type B”.

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably used.

For example, one subframe may be referred to as a “TTI”, a plurality of consecutive subframes may be referred to as a “TTI”, or one slot or one mini-slot may be referred to as a “TTI”. In other words, at least one of a subframe and a TTI may be a subframe (1 ms) in existing LTE, may be a period shorter than 1 ms (for example, 1 to 13 symbols), or may be a period longer than 1 ms. Note that a unit expressing TTI may be referred to as a “slot”, a “mini-slot”, or the like, instead of a “subframe”.

Here, a TTI refers to the minimum time unit of scheduling in radio communication, for example. For example, in LTE systems, a base station performs, for user terminals, scheduling of allocating of radio resources (such as a frequency bandwidth and transmit power that are available for each user terminal) in TTI units. Note that the definition of TTIs is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI”, a “normal subframe”, a “long subframe”, a “slot” and so on. A TTI that is shorter than a normal TTI may be referred to as a “shortened TTI”, a “short TTI”, a “partial or fractional TTI”, a “shortened subframe”, a “short subframe”, a “mini-slot”, a “sub-slot”, a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB))”, a “sub-carrier group (SCG)”, a “resource element group (REG)”, a “PRB pair”, an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth”, and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a UE.

At least one of configured BWPs may be active, and a UE may not need to assume to transmit/receive a certain signal/channel outside the active BWP(s). Note that a “cell”, a “carrier”, and so on in the present disclosure may be used interchangeably with a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Further, the information, parameters, and so on described in the present disclosure may be expressed using absolute values or relative values with respect to certain values, or may be expressed using another corresponding information. For example, a radio resource may be specified by a certain index.

The names used for parameters and so on in the present disclosure are in no respect used as limitations. Furthermore, mathematical expressions that use these parameters, and so on may be different from those explicitly disclosed in the present disclosure. Since various channels (PUCCH, PDCCH, and so on) and information elements may be identified by any suitable names, the various names allocated to these various channels and information elements are in no respect used as limitations.

The information, signals, and so on described in the present disclosure may be represented by using any of a variety of different technologies. For example, data, an instruction, a command, information, a signal, a bit, a symbol, a chip, and so on, described throughout the description of the present application, may be represented by a voltage, an electric current, electromagnetic waves, magnetic fields, a magnetic particle, optical fields, a photon, or any combination thereof.

Also, information, signals, and so on can be output at least one of from a higher layer to a lower layer and from a lower layer to a higher layer. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or added. The information, signals, and so on that has been output may be deleted. The information, signals, and so on that has been input may be transmitted to another apparatus.

Notification of information is by no means limited to the aspects/embodiments described in the present disclosure, and other methods may be used as well. For example, notification of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information block (SIB), and so on), Medium Access Control (MAC) signaling and so on), and other signals or combinations of these.

Note that physical layer signaling may be referred to as “Layer 1/Layer 2 (L1/L2) control information (L1/L2 control signals)”, “L1 control information (L1 control signal)”, and so on. Also, RRC signaling may be referred to as an “RRC message”, and can be, for example, an RRC connection setup message, an RRC connection reconfiguration message, and so on. Also, MAC signaling may be notified using, for example, MAC control elements (MAC CEs).

Also, notification of certain information (for example, notification of “X”) does not necessarily have to be performed explicitly, and can be performed implicitly (by, for example, not reporting this certain information or reporting another piece of information).

A decision may be realized by a value (0 or 1) represented by one bit, by a boolean value (true or false), or by comparison of numerical values (e.g., comparison with a certain value).

Software, irrespective of whether referred to as “software”, “firmware”, “middleware”, “microcode”, or “hardware description language”, or called by other terms, should be interpreted broadly to mean instructions, instruction sets, codes, code segments, program codes, programs, subprograms, software modules, applications, software applications, software packages, routines, subroutines, objects, executable files, execution threads, procedures, functions, and the like.

Also, software, instructions, information, and the like may be transmitted and received via a transmission medium. For example, when software is transmitted from a website, a server, or other remote sources by using at least one of wired technologies (coaxial cable, fiber optic cable, twisted-pair cable, digital subscriber line (DSL), and so on) and wireless technologies (infrared radiation, microwaves, and so on), at least one of these wired technologies and wireless technologies is also included in the definition of the transmission medium.

The terms “system” and “network” used in the present disclosure may be used interchangeably. The “network” may mean an apparatus (for example, a base station) included in the network.

In the present disclosure, the terms such as “precoding”, a “precoder”, a “weight (precoding weight)”, “quasi-co-location (QCL)”, a “Transmission Configuration Indication state (TCI state)”, a “spatial relation”, a “spatial domain filter”, a “transmit power”, “phase rotation”, an “antenna port”, an “antenna port group”, a “layer”, “the number of layers”, a “rank”, a “resource”, a “resource set”, a “resource group”, a “beam”, a “beam width”, a “beam angular degree”, an “antenna”, an “antenna element”, a “panel”, and so on may be used interchangeably.

In the present disclosure, the terms such as a “base station (BS)”, a “radio base station”, a “fixed station,” a “NodeB”, an “eNB (eNodeB)”, a “gNB (gNodeB)”, an “access point”, a “transmission point (TP)”, a “reception point (RP)”, a “transmission/reception point (TRP)”, a “panel”, a “cell”, a “sector”, a “cell group”, a “carrier”, a “component carrier”, and so on can be used interchangeably. The base station may be referred to as the terms such as a “macro cell”, a “small cell”, a “femto cell”, a “pico cell”, and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs)) ). The term “cell” or “sector” refers to part of or the entire coverage area of at least one of a base station and a base station subsystem that provides communication services within this coverage.

In the present disclosure, transmitting information to the terminal by the base station may be interchangeably interpreted as instructing the terminal to perform control/operation based on the information by the base station.

In the present disclosure, the terms “mobile station (MS)”, “user terminal”, “user equipment (UE)”, and “terminal” may be used interchangeably.

A mobile station may be referred to as a “subscriber station”, “mobile unit”, “subscriber unit”, “wireless unit”, “remote unit”, “mobile device”, “wireless device”, “wireless communication device”, “remote device”, “mobile subscriber station”, “access terminal”, “mobile terminal”, “wireless terminal”, “remote terminal”, “handset”, “user agent”, “mobile client”, “client”, or some other appropriate terms in some cases.

At least one of a base station and a mobile station may be referred to as a “transmitting apparatus”, a “receiving apparatus”, a “radio communication apparatus” or the like. Note that at least one of a base station and a mobile station may be a device mounted on a moving object or a moving object itself, and so on.

The moving object is a movable object with any moving speed, and naturally, it also includes a moving object stopped. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type).

Note that at least one of a base station and a mobile station also includes an apparatus which does not necessarily move during communication operation. For example, at least one of a base station and a mobile station may be an Internet of Things (IOT) device such as a sensor.

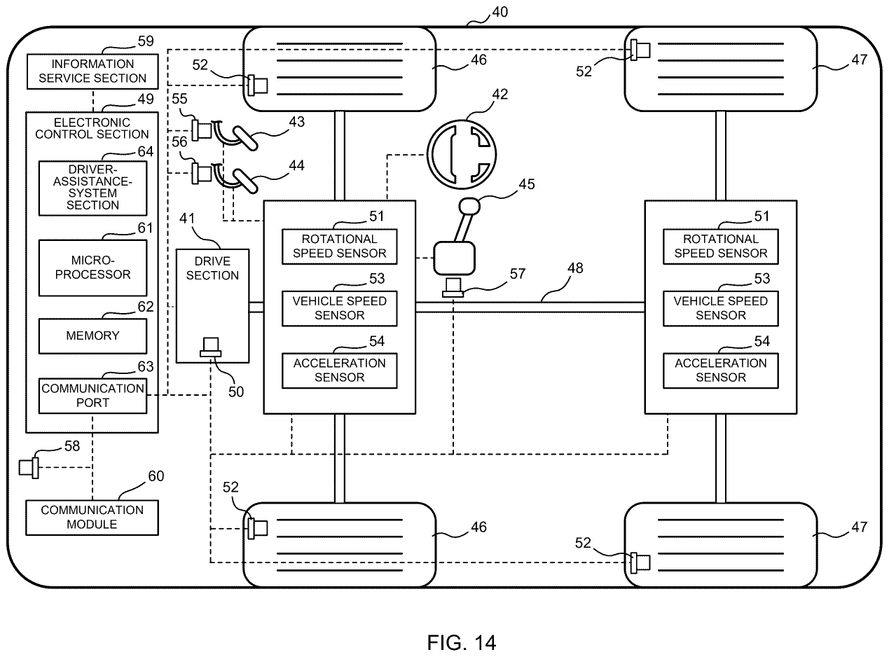

FIG. 14 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 includes at least a steering wheel (also referred to as a handle), and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (10) port) 63. The electronic control section 49 receives, as input, signals from the various sensors 50 to 58 provided in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes: various devices for providing (outputting) various pieces of information such as driving information, traffic information, and entertainment information, such as a car navigation system, an audio system, a speaker, a display, a television, and a radio; and one or more ECUs that control these devices. The information service section 59 provides various pieces of information/services (for example, multimedia information/multimedia service) to an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes: various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor; and one or more ECUS that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, the communication module 60 transmits and receives data (information), via the communication port 63, to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 is a communication device that can be controlled by the microprocessor 61 of the electronic control section 49 and that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals input from the various sensors 50 to 58 to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the received information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may control the driving section 41, the steering section 42, the accelerator pedal 43, the brake pedal 44, the shift lever 45, the right and left front wheels 46, the right and left rear wheels 47, the axle 48, the various sensors 50 to 58, and the like provided in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D)”, “Vehicle-to-Everything (V2X)”, and the like). In this case, user terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as a base station. In this case, the base station 10 may have the functions of the user terminal 20 described above.

Operations which have been described in the present disclosure to be performed by a base station may, in some cases, be performed by an upper node of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

Each aspect/embodiment described in the present disclosure may be used independently, may be used in combination, or may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16(WiMAX (registered trademark)), IEEE 802.20, Ultra-WideBand (UWB), Bluetooth (registered trademark), systems that use other adequate radio communication methods and next-generation systems that are enhanced, modified, created, or defined based on these. A plurality of systems may be combined (for example, a combination of LTE or LTE-A and 5G, and the like) for application.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first”, “second”, and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “deciding (determining)” as in the present disclosure herein may encompass a wide variety of actions. For example, “deciding (determining)” may be interpreted to mean making “decisions (determinations)” about judging, calculating, computing, processing, deriving, investigating, looking up, search and inquiry (for example, searching a table, a database, or some other data structures), ascertaining, and so on.

Furthermore, “deciding (determining)” may be interpreted to mean making “decisions (determinations)” about receiving (for example, receiving information), transmitting (for example, transmitting information), input, output, accessing (for example, accessing data in a memory), and so on.

In addition, “deciding (determining)” as used herein may be interpreted to mean making “decisions (determinations)” about resolving, selecting, choosing, establishing, comparing, and so on. In other words, “deciding (determining)” may be interpreted to mean making “decisions (determinations)” about some action.

“Decide/deciding (determine/determining)” may be used interchangeably with “assume/assuming”, “expect/expecting”, “consider/considering”, and the like.

“The maximum transmit power” described in the present disclosure may mean a maximum value of the transmit power, may mean the nominal maximum transmit power (the nominal UE maximum transmit power), or may mean the rated maximum transmit power (the rated UE maximum transmit power).

The terms “connected”, “coupled”, or any variation of these terms as used in the present disclosure mean any direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access”.

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other”. It should be noted that the phrase may mean that “A and B are each different from C”. The terms “separate”, “coupled”, and so on may be interpreted similarly to “different”.

In the case where the terms “include”, “including”, and variations thereof are used in the present disclosure, these terms are intended to be comprehensive, in a manner similar to the term “comprising”. Furthermore, the term “or” used in the present disclosure is not intended to be an “exclusive or”.

For example, in the present disclosure, where an article such as “a”, “an”, and “the” is added by translation, the present disclosure may include that a noun after the article is in a plural form.

In the present disclosure, “equal to or less than”, “less than”, “equal to or more than”, “more than”, “equal to”, and the like may be used interchangeably. In the present disclosure, words such as “good”, “bad”, “large”, “small”, “high”, “low”, “early”, “late”, “wide”, “narrow”, and the like may be used interchangeably irrespective of positive degree, comparative degree, and superlative degree. In the present disclosure, expressions obtained by adding “i-th” (i is any integer) to words such as “good”, “bad”, “large”, “small”, “high”, “low”, “early”, “late”, “wide”, “narrow”, and the like may be used interchangeably irrespective of positive degree, comparative degree, and superlative degree (for example, “best” may be used interchangeably with “i-th best”, and vice versa).

In the present disclosure, “of”, “for”, “regarding”, “related to”, “associated with”, and the like may be used interchangeably.

Now, although the invention according to the present disclosure has been described in detail above, it is apparent to a person skilled in the art that the invention according to the present disclosure is by no means limited to the embodiments described in the present disclosure. Modifications, alternatives, replacements, etc., of the invention according to the present disclosure may be possible without departing from the subject matter and the scope of the present invention defined based on the descriptions of claims. The description of the present disclosure is provided only for the purpose of explaining examples, and should by no means be construed to limit the invention according to the present disclosure in any way.

1.-6. (canceled)

7. A terminal comprising:
a receiver that receives downlink control information (DCI) including information related to a port of a demodulation reference signal (DMRS) decoded using an orthogonal cover code with a length of more than 2; and
a processor that performs, based on the DCI, processing for at least one of a signal and a channel,
wherein the DCI includes information related to whether an other terminal scheduled in a same symbol as the DMRS is present.

8. The terminal according to claim 7, further comprising a transmitter that reports capability information indicating support for an operation of assuming that a length of the orthogonal cover code is more than 2.

9. The terminal according to claim 7, wherein the processor assumes that multiplexing of a DMRS for which specific information is not configured by higher layer signaling such that the DMRS is decoded using an orthogonal cover code with a length of 2 and a DMRS for which the specific information is configured by the higher layer signaling such that the DMRS is decoded using an orthogonal cover code with a length of more than 2 is restricted in a same code division multiplexing (CDM) group.

10. A radio communication method for a terminal, comprising:
receiving downlink control information (DCI) including information related to a port of a demodulation reference signal (DMRS) decoded using an orthogonal cover code with a length of more than 2; and
performing, based on the DCI, processing for at least one of a signal and a channel,
wherein the DCI includes information related to whether an other terminal scheduled in a same symbol as the DMRS is present.

11. A base station comprising:
a transmitter that transmits, to a terminal, downlink control information (DCI) including information related to a port of a demodulation reference signal (DMRS) decoded using an orthogonal cover code with a length of more than 2; and
a processor that performs, based on the DCI, processing for at least one of a signal and a channel,
wherein the DCI includes information related to whether an other terminal scheduled in a same symbol as the DMRS is present.

12. A system comprising a terminal and a base station,
the terminal comprising:
a receiver that receives downlink control information (DCI) including information related to a port of a demodulation reference signal (DMRS) decoded using an orthogonal cover code with a length of more than 2; and
a processor that performs, based on the DCI, processing for at least one of a signal and a channel,
wherein the DCI includes information related to whether an other terminal scheduled in a same symbol as the DMRS is present, and
the base station comprising:
a transmitter that transmits the DCI.
